(19) United States
(12) Patent Application Publication
(10) Pub. No.: US 2013/0263222 A1
(43) Pub. Date: Oct. 3, 2013

(54) COMPUTER SYSTEM AND SECURITY MANAGEMENT METHOD

(71) Applicants: Emiko Kobayashi, Yokohama (JP); Hiroshi Nakagoe, Tokyo (JP)

(72) Inventors: Emiko Kobayashi, Yokohama (JP); Hiroshi Nakagoe, Tokyo (JP)

(73) Assignee: HITACHI, LTD., Tokyo (JP)

(21) Appl. No.: 13/574,160

(22) PCT Filed: Mar. 27, 2012
(86) PCT No.: PCT/JP2012/057941

§ 371 Date: Jul. 19, 2012

(51) Int. Cl. G06F 21/00

(52) U.S. Cl. 726/4

(57) ABSTRACT

With a plurality of computer apparatuses connected to a network, operation log information, including an operation type and an output destination of a file, and acquisition source information indicating an acquisition source of the file are recorded based on a user's input/output operation; the acquisition source information is managed by relating it with an access authority over the acquisition source of the file; when the operation log information for the user's output operation exists in the operation log information, a range of the access authority over the acquisition source of an output target file, which is a target of the user's output operation, and an addressee user who can access an output destination of the output target file are specified; whether or not the addressee user belongs to the range of the access authority over the acquisition source of the output target file is judged; and if a negative judgment result is obtained, risk information indicating that the user's output operation is an output outside the range of the access authority.

### TECHNICAL FIELD

The present invention relates a computer system and security management method for monitoring a user's operation status, which can become a problem of security management, among the operation status of the user who uses a computer apparatus.

### BACKGROUND ART

Acquisition of intra-company information by a person outside the authority range is the operation with a high possibility of leading to a leakage accident for the company. There is a conventional technique for setting an employee's operation with a high possibility of leading to such a leakage accident as a security policy and detecting the operation which matches the setting. For example, Patent Literature 1 and Patent Literature 2 disclose a technique for managing an input source of a file, which is input to a user terminal, and recording user operations on the file such as copying and output in the user terminal. Furthermore, Patent Literature 1 discloses a method for identifying an output destination at the time of a file output operation, judging whether or not a combination of the output destination and an acquisition source matches conditions of an improper operation, and determining that the combination matches the conditions of the improper operation and the relevant operation is improper if information acquired from inside the relevant organization is output to outside the organization.

There is a risk in not only the output of information to outside the organization, but also acquisition of information by an unauthorized third party even inside the organization. There is a groupware tool as a method for exchanging information while maintaining the access authority over files inside the organization. For example, Patent Literature 3 discloses a method for assigning a file access authority to an addressed person when sending a file storage location URL by e-mail.

A person who creates a file often sets the right to access the file and this causes a burden on the file creator, so that in some cases, an administrator sets the access authority to a server or a folder. If the access authority is set to a server or a folder which is a file storage location as described above, and if a user who has the access authority over the server or the folder downloads a file into a user terminal at hand, the access authority over the downloaded file would not be maintained and there is a possibility that the file might be delivered to a third party outside the range of the access authority.

When the user directly acquires a file stored in the server, it is possible to prevent the file from being delivered to a person outside the range of the access authority by setting the access authority to the server. However, in some case, a file downloaded into a user terminal might be delivered to a person outside the range of the access authority. So, a company requires monitoring by the administrator in order to manage information appropriately.

### CITATION LIST

### [Patent Literature]

[Patent Literature 1] WO2012/001765
[Patent Literature 2] WO2012/001763
[Patent Literature 3] Japanese Patent Application Laid-Open (Kokai) Publication No. 2008-262293

### SUMMARY OF INVENTION

### Problems to be Solved by the Invention

Even if the administrator wishes to strictly manage intra-company information by setting access limitations, the problem is that particularly if a user copies and moves a file regarding which the access authority is set to its storage location, the access authority over the copied file becomes unclear. In this case, there is a possibility that the operation which cannot be perceived by the administrator might be performed as in a case where the user might intentionally or willfully transfer the file to a person outside the range of the access authority.

It is an object of the present invention to specify an addressee user who can access an output destination of an output target file, which is a target of the user's output operation, and to monitor whether or not the access authority over an acquisition source of the output target exists as an access authority relating to the specified addressee user.

### Means for Solving the Problems

With a plurality of computer apparatuses connected to a network according to the present invention in order to achieve the above-described object, operation log information including an operation type of a user's input/output operation and an output destination of a file selected by the user's input/output operation, and acquisition source information indicating an acquisition source of the file are recorded based on the user's input/output operation; the recorded operation log information is managed by associating it with each computer apparatus, and the recorded acquisition source information is managed by relating it with the access authority over an acquisition source of the file; when the operation log information for the user's output operation exists in the operation log information, a range of the access authority over the acquisition source of an output target file, which is a target of the user's output operation, is specified based on the acquisition source information and an addressee user who can access an output destination of the output target file is specified based on user information; whether or not the addressee user belongs to the range of the access authority over the acquisition source of the output target file is judged; and if a negative judgment result is obtained, risk information indicating that the user's output operation is an output operation by the user outside the range of the access authority over the acquisition source of the output target file is output.

### Advantageous Effects of Invention

According to the present invention, an addressee user who can access an output destination of an output target file which is a target of the user's output operation can be specified and whether or not the access authority over an acquisition source of the output target exists as an access authority relating to the specified addressee user can be monitored.

### BRIEF DESCRIPTION OF DRAWINGS

FIG. 1 is a configuration diagram showing hardware and a logical structure of a computer system according to a first embodiment of the present invention.

FIG. 2 is a configuration diagram showing a function module structure of a manager program and an agent program according to the first embodiment of the present invention.

FIG. 3 is a configuration diagram of an acquisition source management table managed by the agent program.

FIG. 4 is a configuration diagram of an operation log information management table managed by the manager program.

FIG. 5 is a configuration diagram of an acquired information management table managed by the manager program.

FIG. 6 is a configuration diagram of a problem operation information management table managed by the manager program.

FIG. 7 is a configuration diagram of user information managed by a directory server.

FIG. 8 is a configuration diagram of access control information managed by the directory server.

FIG. 9 is a flowchart for explaining processing by the agent program when inputting a file.

FIG. 10 is a flowchart for explaining processing by the agent program when outputting a file.

FIG. 11 is a flowchart for explaining the entire processing by the manager program.

FIG. 12 is a flowchart for explaining acquisition source access authority specifying processing by the manager program.

FIG. 13 is a flowchart for explaining output destination specifying processing by the manager program.

FIG. 14 is a screen structure diagram showing a display example of an output screen by the manager program.

### DESCRIPTION OF EMBODIMENTS

An embodiment of the present invention will be explained below with reference to the drawings. Incidentally, expressions such as a “table” and a “DB (database)” will be used to describe information relating to this invention in the following explanation, but such information may be expressed in a form other than data structures such as tables or DBs (databases). Accordingly, the “tables,” “DBs (databases),” and so on may sometimes be simply called “information” in order to show no dependence on the data structures. Furthermore, when explaining the content of each piece of information, the expressions “identification information,” “identifier,” “name,” or “ID” may be used and these expressions are exchangeable.

Furthermore, a “program” may be used as a subject in the following explanation; however, when the program is executed by a processor or a CPU, specified processing is executed by using a memory and a communication port (communication control device) and, therefore, the processor or the CPU may be used as a subject in the explanation. Also, processing disclosed as a program being the subject may be processing executed by a computer such as a management server or an information processing unit. Furthermore, a part or whole of the program may be implemented by dedicated hardware. Various programs may be installed to each computer via a program distribution server or storage media.

Incidentally, the management server includes input-output devices. Example of such input-output devices can be a display, a keyboard, and a pointer device, but may include any other devices. As substitutes for the input-output devices, a serial interface and an Ethernet interface may be used as the input-output devices; and input and display by the input-output devices may be substituted by connecting a display computer including a display, keyboard, or pointer device, to the above-mentioned interfaces, having the display computer display information to be displayed, and accepting inputs.

### First Embodiment

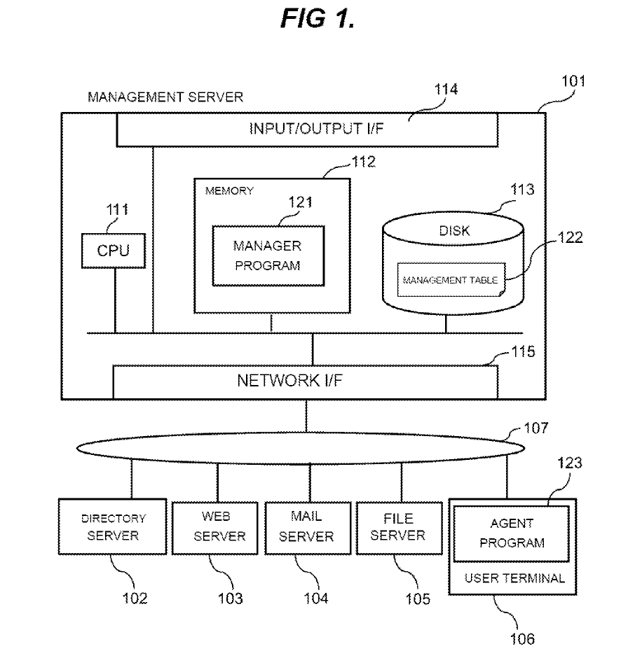

FIG. 1 is a configuration diagram including hardware and a logical structure of a computer system that implements the present invention. Referring to FIG. 1, the computer system includes a management server 101, a directory server 102 for performing centralized management of user information and resource information about, for example, computers inside the computer system and providing a directory service, a web server 103, a mail server 104, a file server 105 for sharing files, and a plurality of user terminals 106 which are management targets of the management server 101 and are operated by each user. The management server 101, the directory server 102, the web server 103, the mail server 104, the file server 105, and each user terminal 106 are connected to a network 107 and send and receive information via the network 107.

Each of the servers 101 to 105 and the user terminals 106 is a computer apparatus including one or more central processing units (CPUs) 111, a memory 112, a secondary storage device 113 such as a hard disk, an input/output interface 114 for controlling inputs from a keyboard and a mouse and output information to a display, and a network interface 115 for connection to the network 107 and is configured as a computer apparatus for processing information by using computer resources including hardware and software.

A manager program (hereinafter sometimes referred to as the manager) 121 is loaded into the memory 112 for the management server 101 and the manager 121 loaded into the memory 112 is executed by the CPU 111. The secondary storage device 113 is constructed of, for example, a hard disk and management tables or database information for managing, for example, operation logs and acquired information are stored in a management table storage area 122 of the secondary storage device 113.

An agent program (hereinafter sometimes referred to as the agent) 123 is loaded into the memory for each user terminal 106 and the agent 123 loaded into the memory is executed by the CPU. Furthermore, operation logs and so on are stored in the secondary storage device (disk) for each user terminal 106.

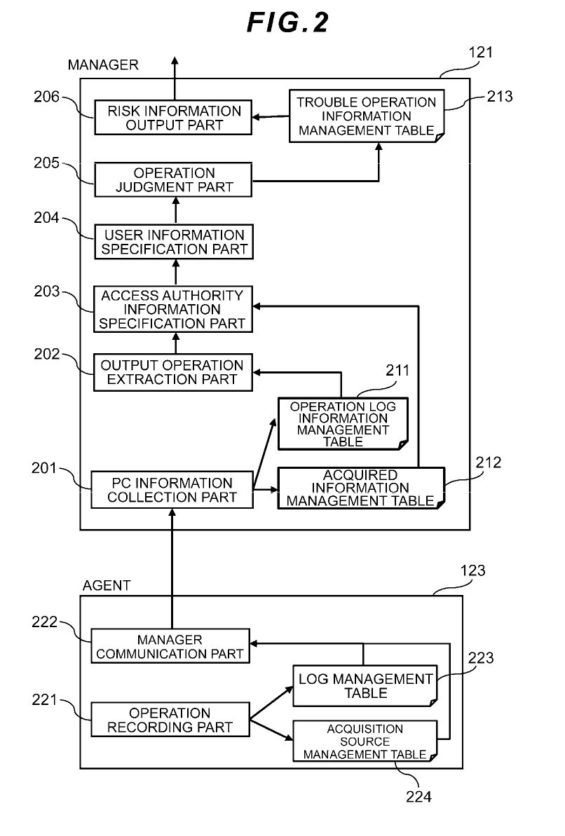

FIG. 2 shows a function module structure of the manager 121 and the agent 123. Referring to FIG. 2, the manager 121 includes: a PC information collection part 201 for collecting, for example, operation logs from the agent 123 of each user terminal 106 which becomes a management target; an output operation extraction part 202 for extracting operation logs of file output operations from the collected operation logs; an access authority information specification part 203 for specifying access authority information about the relevant file based on acquisition source information of the file on which the output operation is performed; a user information specification part 204 for specifying a user of the file at an output destination; an operation judgment part 205 for judging whether or not the user of the file at the output destination is a user within the range of the access authority; and a risk information output part 206 used when the operation judgment part 205 obtains a negative judgment result, for outputting information indicating that the user of the file at the output destination is a user outside the range of the access authority, as problem operation risk information to a screen managed by the administrator.

Under this circumstance, the respective parts including the PC information collection part 201, the output operation extraction part 202, the access authority information specification part 203, the user information specification part 204, the operation judgment part 205, and the risk information output part 206 are configured as elements of part of the manager 121.

The PC information collection part 201 records and manages the operation logs collected from the agent 123 in an operation log information management table 211, also collects acquisition source information about files to each user terminal 106 from the agent 123, and records and manages the collected acquisition source information in an acquired information management table 212.

For example, if file-attached mail transmission or web upload exists as the operation type in the operation log information recorded by the PC information collection part 201, the output operation extraction part 202 extracts the file-attached mail transmission or the web upload as operation log information recorded for the user's output operation.

If it is determined that the file-attached mail transmission or the web upload exists as the operation type in the operation log information recorded by the PC information collection part, the access authority information specification part 203 refers to the acquired information management table 212 based on the file identifier of a file corresponding to the file-attached mail transmission or the web upload extracted by the output operation extraction part 202 and specifies the range of the access authority over the acquisition source of the output target file, which is a target of the user's output operation, by collecting access control information from the directory server 102.

The user information specification part 204 collects user information based on the operation log information indicating the output destination of the output target file which is the target of the user's output operation, for example, a mail address, and specifies an addressee user who can access the output destination of the output target file which is the target of the user's output operation.

The operation judgment part 205 judges, based on the user information and the access control information, whether or not the addressee user specified by the user information specification part 204 belongs to the range of the access authority over the acquisition source of the output target file which is the target of the user's output operation; and if the operation judgment part 205 obtains a negative judgment result, it records and manages risk information indicating that the user's output operation is an output operation by a user outside the range of the access authority over the acquisition source of the output target file which is the target of the user's output operation, as problem operation information in the problem operation information management table 213.

Now, regarding the judgment of whether or not the addressee user is within the range of the access authority over the acquisition source of the output target file, for example, whether or not a group to which the addressee user belongs exists in groups which have the access authority over the acquisition source of the output target file which is the target of the user's output operation is judged.

The risk information output part 206 manipulates the risk information recorded in the problem operation information management table 213 and outputs the manipulated risk information as screen information via the input/output interface 114.

The agent 123 mounted in each user terminal 106 includes an operation recording part 221 for detecting and recording the user's operations and a manager communication part 222 for sending operation logs and file acquisition source information to the manager 121. Under this circumstance, the respective parts including the operation recording part 221 and the manager communication part 222 are configured as elements of part of the agent 123.

When the user operates the user terminal 106, the operation recording part 221 records and manages the user's operation content as an operation log in a log management table 223 and records and manages information about a file acquisition source in an acquisition source management table 224.

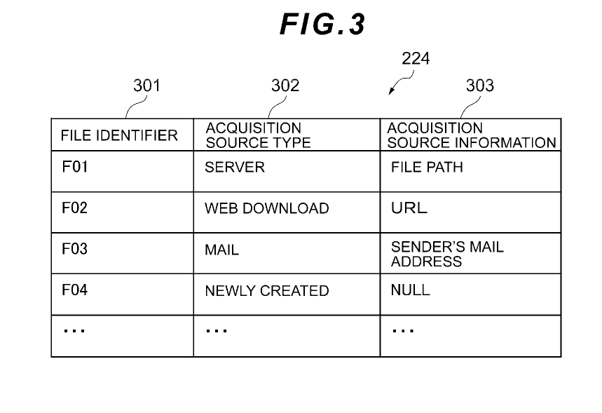

FIG. 3 is a configuration diagram of the acquisition source management table managed by the agent. Referring to FIG. 3, the acquisition source management table 224 is a table used at the user terminal 106 for managing files, for which input operations are performed, and is a table for managing the location where the relevant file was placed before the input operation performed by the user terminal 106 regardless of any subsequent file operations. The acquisition source management table 224 includes a file identifier field 301, an acquisition source type field 302, and an acquisition source information field 303.

The file identifier is an identifier for uniquely identifying a file in the system. This file identifier is unique in the system unless there is another file with the same content. A hash value of the file which is calculated by the agent 123 is used as the file identifier. For example, “F01” is stored, as the identifier for uniquely identifying the file, in a record of the file identifier field 301. Incidentally, “F01” is used as the file identifier in order to simplify the explanation, but the hash value of the file is actually used.

The acquisition source type is information indicating by what means the file was acquired by the user terminal 106, and is information for specifying the type of the file acquisition source. For example, if the file was acquired from the file server 105 by copying or moving it, information “Server” is stored in a record of the acquisition source type field 302; and if the file was downloaded from the web server 103, information “Web Download” is stored in a record of the acquisition source type field 302. Furthermore, if the file was received from the mail server 104, “Mail” is stored in a record of the acquisition source type field 302; and if the file was newly created, “Newly Created” is stored in a record of the acquisition source type field 302.

The acquisition source information is information for specifying the file acquisition source. For example, if the file was copied or moved from the file server 105, information indicating a file path (including a server name or an IP address of the server) of a copy source or a movement source is stored in a record of the acquisition source information field 303. Also, if the file was downloaded from the web server 103, information indicating a download source URL is stored in a record of the acquisition source information field 303. Moreover, if the file was received from the mail server 104, information indicating a sender's mail address is stored in a record of the acquisition source information field 303. Furthermore, if there is no acquisition source, for example, when the file was newly created, or if the file was copied from a medium or a portable storage medium, information indicating NULL is stored in a record of the acquisition source information field 303.

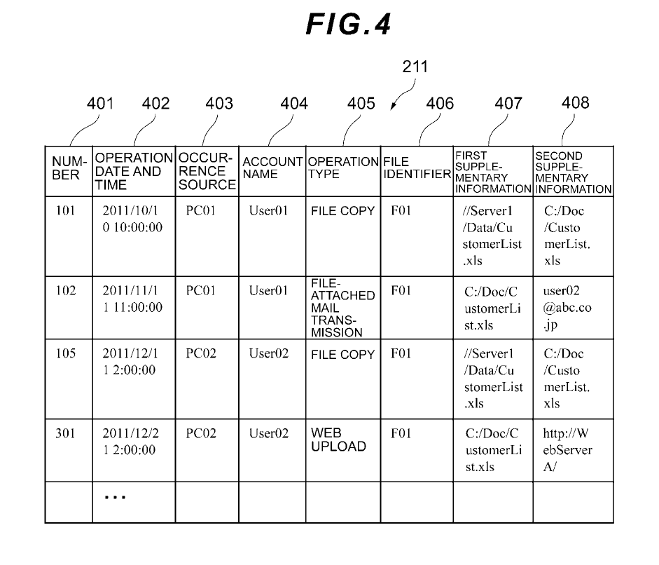

FIG. 4 is a configuration diagram of the operation log information management table managed by the manager program. Referring to FIG. 4, the operation log information management table 211 is a table used to record and manage the information collected by the PC information collection part 201 and includes a number field 401, an operation date and time field 402, an occurrence source field 403, an account name field 404, an operation type field 405, a file identifier field 406, a first supplementary information field 407, and a second supplementary information field 408.

The number is a number for uniquely identifying an operation log. If the number of the operation log is 101, information “101” is stored in a record of the number field 401.

The operation date and time are information indicating a date and time when the user performed the operation on the file. The information indicating the date and time when the user performed the operation on the file is stored in a record of the operation date and time field 402.

The occurrence source is information for specifying the occurrence source of the operation log. For example, if the user terminal 106 is constructed of a computer apparatus PC01, “PC01” is stored in a record of the occurrence source field 403.

The account name is information for specifying the user who uses the user terminal 106. For example, “User01” is stored as information for specifying the user who uses the user terminal 106 PC01 in a record of the account name field 404.

The operation type is information for specifying the type of operation on the file. For example, in a case of a file copy operation, information “File Copy” is stored in a record of the operation type field 405. Also, if the operation on the file is file-attached mail transmission, information “File-attached Mail Transmission” is stored in a record of the operation type field 405; and if the operation on the file is a web upload, information “Web Upload” is stored in a record of the operation type field 405. Furthermore, examples of the operation types include, in addition to a file creation, deletion, and movement operations, folder operation, file attachment to mail, reception of file-attached mail, saving of a file attached to mail, messenger transmission or reception of a file-attached message, web access downloading, and printing.

The file identifier is an identifier for uniquely identifying a file in the system and is the same identifier as the file identifier in FIG. 3. Incidentally, even if a plurality of files are selected by one operation, one record is assigned to each file and information of each file is registered in each record. Therefore, for example, if there are a plurality of attached files in the file-attached mail transmission, as many records as the number of files are assigned to the operation log information management table 211 and information of each file is registered in each record.

The first supplementary information is information for specifying, for example, a file copy source and the second supplementary information is information for specifying, for example, a file copy destination. The information for specifying, for example, the file copy source is stored in a record of the first supplementary information field 407 and the information for specifying, for example, the file copy destination is stored in a record of the second supplementary information field 408.

Various information is registered in a record of the first supplementary information field 407 and a record of the second supplementary information field 408 according to the operation type. For example, if the operation type is the file-attached mail reception, a mail sender's mail address and a file name are registered in a record of the first supplementary information field 407; and if the operation type is saving of a file attached to mail, a sender's mail address and a file path of a saved location are registered. Furthermore, in a case of the file-attached mail transmission, a file path which was read at the time of attachment and a destination mail address of the mail are registered in a record of the second supplementary information field 408. If there are a plurality of destination mail addresses, the respective mail addresses are separated by commas and registered.

In a case of a copy operation or a movement operation between devices such as copying of a file from the file server 105 to the user terminal 106, a file path (including a device name or an IP address of the device) of a copy source or a movement source is registered in a record of the first supplementary information field 407 and a file path of a copy destination or a movement destination is registered in a record of the second supplementary information field 408.

If a file is downloaded from the web server 103 into the user terminal 106, a download source URL is registered in a record of the first supplementary information field 407 and a file path of a saved location is registered in a record of the second supplementary information field 408. If a file is uploaded from the user terminal 106 into the web server 103, a read file path is registered in a record of the first supplementary information field 407 and an uploaded location URL is registered in a record of the second supplementary information field 408.

Incidentally, the log management table 223 managed by the agent 123 can be configured of the operation log information management table 211 excluding the occurrence source field 403.

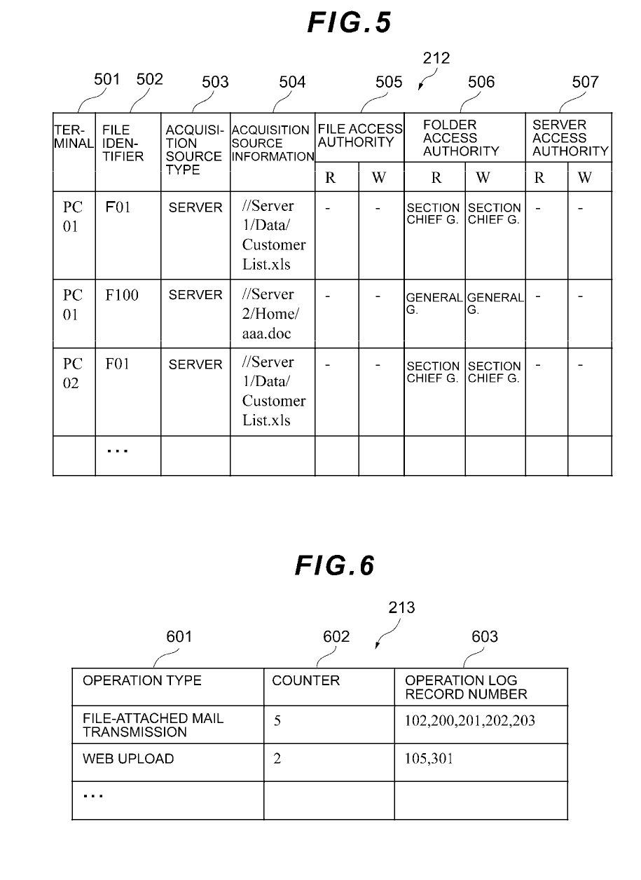

FIG. 5 is a configuration diagram of the acquired information management table managed by the manager program. Referring to FIG. 5, the acquired information management table 212 is a table used to manage the information collected by the PC information collection part 201 from each user terminal 106 by relating it to access authority information of the acquisition source and includes a terminal field 501, a file identifier field 502, an acquisition source type field 503, an acquisition source information field 504, a file access authority field 505, a folder access authority field 506, and a server access authority field 507.

The terminal is information indicating a terminal which is an information supply source. For example, if the user terminal 106 is the computer apparatus “PC01,” information “PC01” is stored in a record of the terminal field 501.

The file identifier is an identifier for uniquely identifying a file in the system and is the same identifier as the file identifier in FIG. 3.

The acquisition source type is information indicating by what means a file was acquired by the user terminal 106, and is information for specifying the type of a file acquisition source. For example, if a file was acquired from the file server 105, information “Server” is stored in a record of the acquisition source type field 503.

The acquisition source information is information for specifying the file acquisition source. For example, if a file was copied or moved from the file server 105, information indicating a file path (including a folder path) of a copy source or a movement source is stored in a record of the acquisition source information field 504.

The file access authority is information indicating whether or not read access (R) and write access (W) are set as the access authority to a file. If the read access (R) or the write access (W) is set as the access authority to a file, the name of an object that has the access authority is stored in a record of the file access authority field 505. Incidentally, if neither the read access (R) nor the write access (W) is set as the access authority to a file, “−” is stored in a record of the file access authority field 505.

The folder access authority is information indicating whether or not the read access (R) and the write access (W) are set as the access authority to a folder. If the read access (R) or the write access (W) is set as the access authority to a folder, the name of an object that has the access authority is stored in a record of the folder access authority field 506. For example, if both the read access (R) and the write access (W) are set respectively to a section chief group, “Section Chief G” is stored in a record of the folder access authority field 506.

The server access authority is information indicating whether or not the read access (R) and the write access (W) are set as the access authority to a server. If the read access (R) or the write access (W) is set as the access authority to a server, the name of an object that has the access authority is stored in a record of the server access authority field 507. Incidentally, if neither the read access (R) nor the write access (W) is set as the access authority to a server, “−” is stored in a record of the file access authority field 507.

FIG. 6 is a configuration diagram of the problem operation information management table managed by the manager program. Referring to FIG. 6, the problem operation information management table 213 is a table for registering and managing the judgment result of the operation judgment part 205 for each operation type and includes an operation type field 601, a counter field 602, and an operation log record number field 603.

The operation type is information for specifying the type of operation on a file (target file) which is a target of the user's input/output operation. For example, if the user's operation on a file is file-attached mail transmission, information “File-attached Mail Transmission” is stored in a record of the operation type field 601; and if the user's operation on a file is a web upload, information “Web Upload” is stored in a record of the operation type field 601.

The counter is information for counting negative judgment results among the judgment results of the operation judgment part 205. For example, if the operation judgment part 205 determines that an addressee user who can access an output destination of a target file which is a target of the user's output operation is a user outside the range of the access authority, the counter is information for counting the number of times of the output operations as the number of times of problem operations.

Information indicated by the number of times of problem operations is stored in a record of the counter field 602. For example, if the problem operation is “file-attached mail transmission” and the number of times of the problem operations is five, “5” is stored in a record of the counter field 602.

The operation log record number is information for specifying a record number of an operation log which is a target of a problem operation. Information for specifying the record number of an operation log which is a target of a problem operation is stored in a record of the operation log record number field 603. For example, if the problem operation is “file-attached mail transmission” and its record numbers are 102, 200, 201, 202, 203, “102, 200, 201, 202, 203” are stored in a record of the operation log record number field 603.

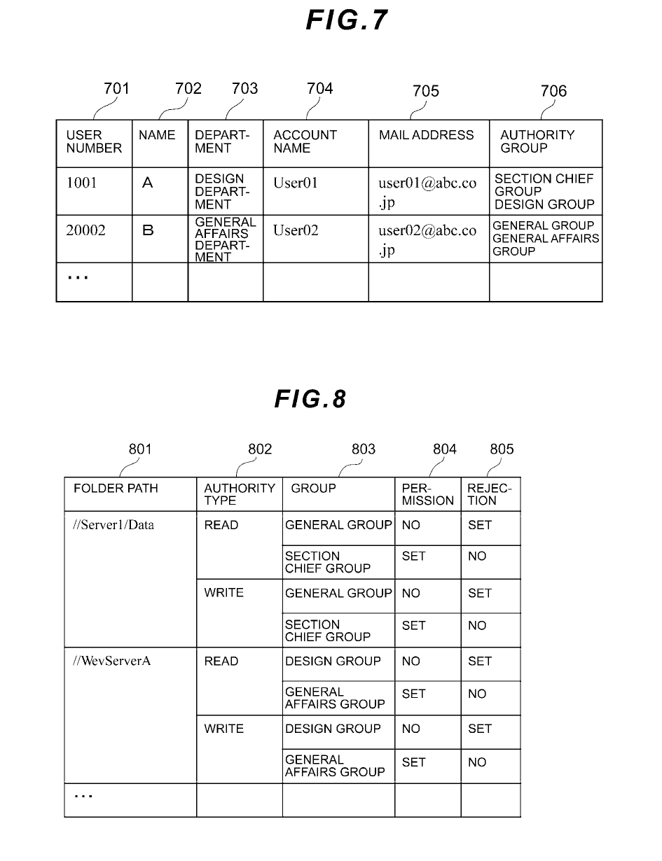

FIG. 7 is a configuration diagram of user information managed by the directory server. Referring to FIG. 7, the user information managed by the directory server 102 is user information about users who use the user terminal 106; and includes attributes and attribute values of the users.

Specifically speaking, the user information includes, as the attributes, a user number 701 for identifying a user, a name 702 of the user, a department 703 to which the user belongs, an account name 704 used when the user operates and logs into the user terminal 106, a mail address 705 specific to the user, and an authority group 706 for specifying a group to which the user belongs and which has the access authority in the system. Incidentally, the authority group 706 may sometimes store a plurality of values. For example, if the user belongs to a section chief group and a design group as the authority groups, “Section Chief Group and Design Group” are stored as attribute values in a record of the user's authority group 706.

FIG. 8 is a configuration diagram of access control information at a computer managed by the directory server. Referring to FIG. 8, the access control information at a computer managed by the directory server 102 includes attributes and attribute values of the access control information.

Specifically speaking, the access control information includes, as the attributes, a folder path 801 for designating the location of a folder or a file to which accessibility is set, an authority type 802 indicating the type of authority information, a group 803 indicating a group to which the user using the user terminal 106 belongs, a permission 804 indicating a permission of access to the folder path 801, and a rejection 805 indicating a rejection of access to the folder path 801. Incidentally, read and write with respect to the folder path 801 are used in FIG. 8 as attribute values of the authority type 802.

Now, for example, if the access authority is not permitted to “General Group” and the access authority is permitted to “Section Chief Group” for a first record of the folder path 801 with respect to “Read” and “Write” of the authority type 802, “No” is stored in the permission 804 for “General Group” and “Set” is stored in the rejection 805 for “General Group” with respect to “Read” and “Write.” On the other hand, “Set” is stored in the permission 804 for “Section Chief Group” and “No” is stored in the rejection 805 for “Section Chief Group” with respect to “Read” and “Write.”

Incidentally, access control information for specifying the access authority with respect to the web server 103, the mail server 104, and the file server 105 can be configured in the same manner as the access control information shown in FIG. 8.

Next, the user's operations and processing by the agent 123 will be explained. This embodiment is targeted a user's operation to acquire an electronic file and save the acquired electronic file in the user terminal 106 and also targeted at file operations such as a file name change and a folder movement in the user terminal 106 or output of a file from the user terminal 106. If the user performs the operation by using an I/F such as a mailer or a browser under this circumstance, the agent 123 detects the user's operation by means of, for example, acquisition of I/O to the file system or packets output to the network 107, and records the content of the detected operation in the log management table 223 in accordance with a defined format.

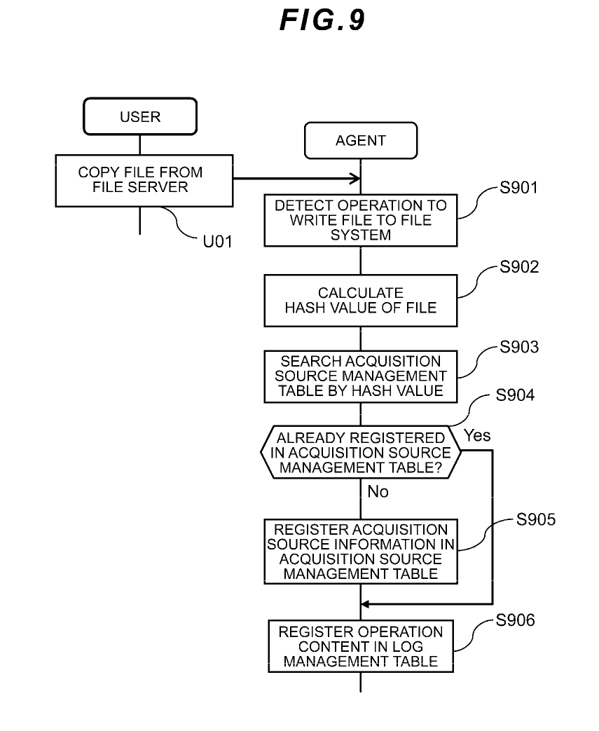

Next, the user's operations and specific processing by the agent 123 will be explained in accordance with a flowchart in FIG. 9. This processing is processing by the agent 123 at the time of file input and is executed by the CPU for the user terminal 106.

When the user performs the operation to, for example, copy and save an electronic file form the file server 105 (step U01), the agent 123 detects writing of the file to the file system (step S901) and calculates a hash value of the file (step S902).

Next, the agent 123 searches the acquisition source management table 224 based on the file identifier acquired from the hash value (step S903) and judges whether the file identifier has already been registered or not (step S904); and if the file identifier has not been registered, the agent 123 registers information about the file identifier and the acquisition source in the acquisition source management table 224 (step S905). When this happens, for example, the server is registered in the acquisition source type and the file path including the server name or the IP address of the server is registered in the acquisition source information as the information about the acquisition source in the acquisition source management table 224.

Subsequently, if the agent 123 determines in step S904 that the file identifier has already been registered, or after the processing in step S905, the agent 123 registers the operation to copy the file from the file server 105 as an operation log in the log management table 223 (step S906) and terminates the processing in this routine.

Now, examples of the user's operation which will result in writing of a file to the file system include not only copying or movement of a file from the file server 105, but also a download of a file from the web site 103, saving of an attached file at the time of reception of e-mail, and creation and saving of a file by the user. The respective operation types are registered in the operation type field of the log management table 223 so that these operations can be identified.

Furthermore, for example, if the user changes the name of a file as the operation to change the file saved in the user terminal 106, the agent 123 detects writing of the changed file to the file system, calculates a hash value of the changed file, and searches the acquisition source management table 224 based on the calculated hash value (file identifier); and when this happens, since data of the file has not been changed even though the name was changed, it is determined that the hash value has already been registered (in the case of Yes in step S904).

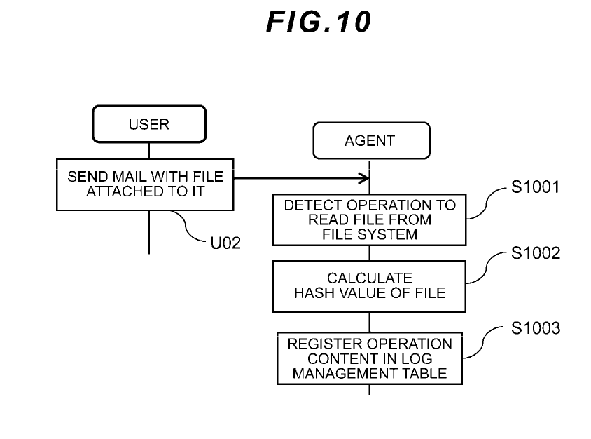

Next, processing by the agent program when a file is output from the user terminal will be explained in accordance with a flowchart in FIG. 10.

Firstly, for example, if the user performs an operation to send mail with a file attached thereto (step U2), the agent 123 detects an operation to read the file from the file system (step S1001), calculates a hash value of the file (step S1002), registers the file identifier acquired from the calculated hash value and output destination information (destination address of the mail), as an operation log, in the log management table 223 (step S1003), and terminates the processing in this routine.

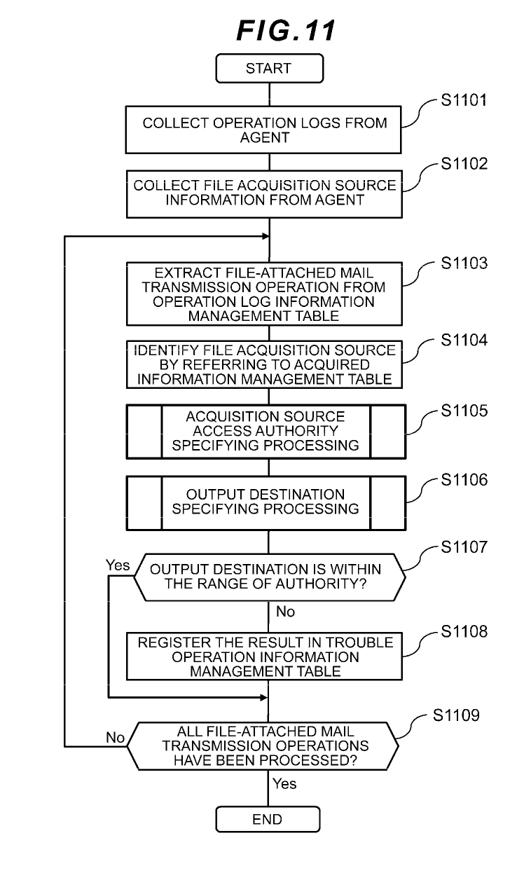

Next, processing by the manager program will be explained in accordance with a flowchart in FIG. 11. The manager 121 is activated periodically, collects operation logs from the agent 123 for each user terminal 106, and registers the collected operation logs in the operation log information management table 211 (step S1101). Incidentally, the manager 121 may execute the processing for collecting the operation logs and saving them in the operation log information management table 211 at timing separately from the following processing (steps S1103 to S1109). Furthermore, a method executed by the agent 123 periodically sending operation logs and the manager 121 receiving the periodically sent operation logs may be used.

Then, the manager 121 collects file acquisition source information from each agent 123 (step S1102). The manager 121 may execute this processing at the same timing as acquisition of the operation logs. Furthermore, the agent 123 may send the acquisition source information to the management server 101 at the timing when the agent 123 registers the acquisition source information in the acquisition source management table 224.

Subsequently, the manager 121 extracts a file output operation from the operation log information management table 211 with respect to logs of the previous processing and thereafter as targets (step S1103). The file output operation herein means outputs via the network such as file-attached mail transmission, web uploading, and copying to the file system of another device. If the file output operation is file-attached mail transmission, the manager 121 extracts a record whose operation type is the file-attached mail transmission, from the operation log information management table 211.

Next, the manager 121 refers to the acquired information management table 212 based on the file identifier included in the extracted record and identifies the file acquisition source (step S1104). If the file was copied from the file server 105, the file acquisition source is a file path recorded in the acquisition source information.

Since the agent 123 sends the acquisition source information to the manager 121 separately from the operation log information in this example, the manager 121 searches the acquired information management table 212 and identifies the acquisition source. As another method, there is a method executed by the agent 123 adding the file acquisition source information to the record of the operation log information and sending it to the manager 121. In this case, the manager 121 identifies the acquisition source by skipping the processing for extracting the output operation from the operation log information and then searching the acquired information management table 211.

Next, the manager 121 executes processing for specifying the access authority with respect to the identified acquisition source (S1105) and then executes processing for specifying the output destination (S1106).

Subsequently, the manager 121 judges whether or not the specified output destination is a user included in the range of the access authority over the acquisition source (S1107). When this is performed, the manager 121 judges whether or not an account name or an authority group of the user who has the specified destination mail address matches information of the file or the folder or the server of the access authority information of the relevant file.

If the manager 121 determines in step S1107 that the account name or the authority group of the user who has the specified destination mail address matches the relevant information, that is, there is no program, it proceeds to processing in step S1109; and if the manager 121 finds no matching information in step S1107, that is, if the manager 121 determines that the file is output to outside the range of the access authority, it registers the judgment result in the problem operation information management table 213 (S1108).

Then, the manager 121 refers to the operation log information management table 211 and judges whether or not all file-attached mail transmission operations have been executed, based on the target log (S1109); and if the manager 121 obtains a negative judgment result in this step 1109, it returns to the processing in step S1103 and repeats the processing from step S1103 to S1109; and if the manager 121 obtains an affirmative judgment result in step S1109, it determines that all the operations have been executed, and terminates the processing in this routine.

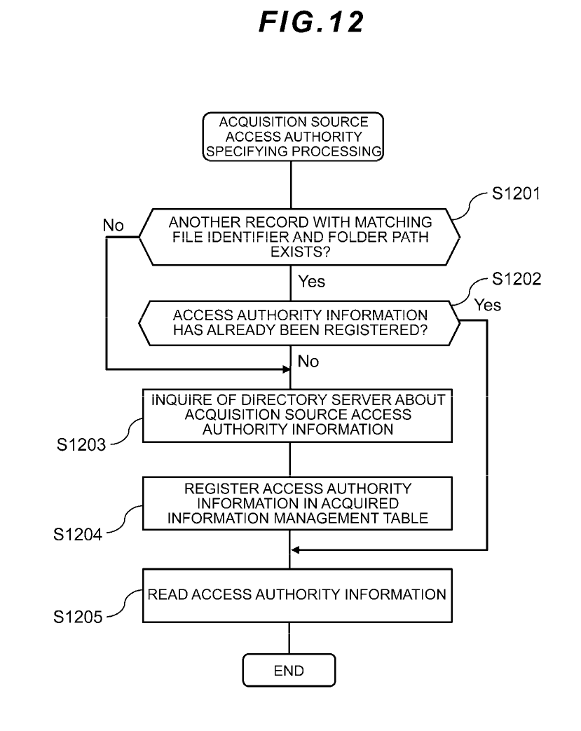

Next, the input source access authority specifying processing will be explained in accordance with a flowchart in FIG. 12. This processing is the specific content of step S1105 in FIG. 11.

The manager 121 refers to the acquired information management table 212 based on the file acquisition source and searches the acquired information management table 212 to check if another record with the same file identifier or the same folder path in the file path exists or not (step S1201).

If the manager 121 determines that there is no matching data in the acquired information management table 212, it proceeds to processing in step S1203; and if the manager 121 determines that matching data exists in the acquired information management table 212, it judges whether or not the access authority information is registered in the acquired information management table 212 (step S1202).

If the manager 121 determines in step S1202 that the access authority information of the acquisition source is registered in the acquired information management table 212, it proceeds to processing in step S1205; and if the manager 121 determines in step S1202 that the access authority information of the acquisition source is not registered in the acquired information management table 212, it inquires of the directory server 102 about the access authority information of the target file acquisition source (step S1203) and registers the access authority information, which is acquired from the directory server 102, in a corresponding record of the acquired information management table 212 (step S1204).

Subsequently, the manager 121 reads the access authority information of the target file acquisition source from the acquired information management table 212 (S1205) and terminates the processing in this routine. Incidentally, if the same file has been processed by another user terminal 106, the access authority information is registered in the acquired information management table 212. In this case, the manager 121 reads the registered access authority information from the acquired information management table 212.

The method of inquiring of the directory server 102 about the access authority over the acquisition source with respect to the file on which the output operation was performed has been explained here; however, as another method, there is a method of acquiring information from the agent 123 regardless of the file, on which the output operation was performed, and registering the acquired information in the acquired information management table 212, then inquiring of the directory server 102 at the time of registration of the acquired information, and registering the access authority information, which is acquired from the directory server 102, in the acquired information management table 212.

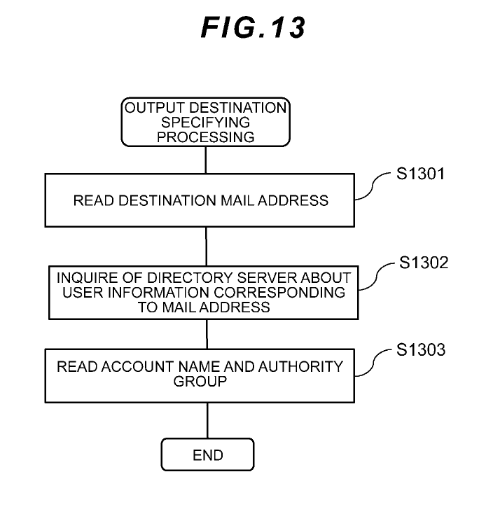

Next, the output destination specifying processing will be explained in accordance with a flowchart in FIG. 13. This processing is the specific content of step S1106 in FIG. 11.

The manager 121 reads the destination mail address, which is registered in the second supplementary information field 408, from the record extracted from the operation log information management table 211 in S1103 of FIG. 11 (S1301) and inquires of the directory server 102 about the corresponding user information with respect to the read destination mail address (S1302).

Subsequently, the manager 121 reads the attribute values of the account name and the authority group, which indicate the attributes of the user, from the user information acquired from the directory server 102 (S1303) and terminates the processing in this routine. If a plurality of mail addresses are registered under this circumstance, the manager 121 searches and reads information of each mail address.

When whether or not within the range of the access authority is judged, for example, it is determined based on the acquired information management table 212 that the section chief group has the folder access authority over the file identifier F01. Furthermore, if the account name of the specified user at the output destination is User02, it is determined based on the user information in FIG. 7 that the authority group of the user at the specified output destination (B who has the mail address user02@abc.co.jp) is the general group. Therefore, if the output destination of the user's output operation of User01 (a record number 102 of the operation log information management table 211) is User02, it means that the user User01 performed sent file-attached mail transmission to the user other the user who belongs to the section chief group. In this case, it is determined that the user's output operation of User01 is the output operation to the user outside the range of the access authority.

Here in this embodiment, the directory server 102 performs centralized management of the access control information together with the user information; however, whether reading or writing can be performed on individual user accounts may be controlled for each server or folder instead of each authority group. Furthermore, the access control information may be constructed as an independent access control management server and each user terminal 106 may also locally manage and control the access control information. In that case, in step S1105 in FIG. 11, the manager 121 inquires of the access management server or the server of the specified acquisition source about the access control information.

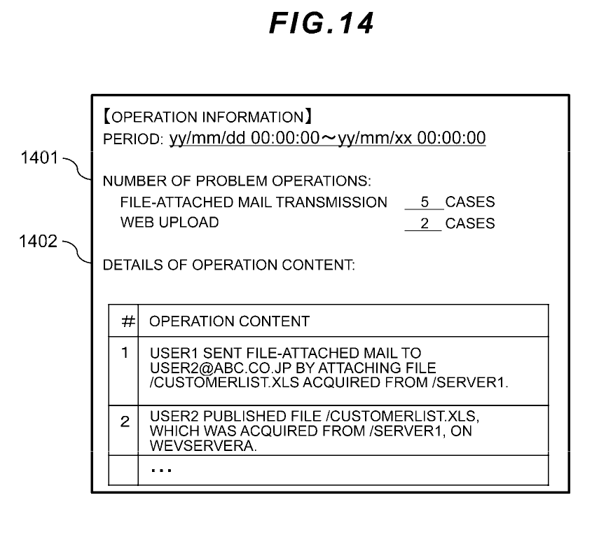

FIG. 14 shows a display example of a screen output by the manager program. Referring to FIG. 14, count information 1401 about the number of problem operations for each operation type and the details of the operation content 1402 are displayed, as information output by the manager 121, on the screen of a display device connected to the input/output interface 114 for the management server 101. Information of operation log records and text information including the relevant file acquisition source information are displayed as the operation content on the details of the operation content 1402.

Therefore, if the computer system shown in FIG. 1 is installed at a company and each employee operates the user terminal 106 and the administrator operates the management server 101, the administrator can become aware of the status of operations by each employee to output information to persons outside the disclosure range (persons outside the range of the access authority), by viewing the screen in FIG. 14.

According to this embodiment, even in a case where the destination of mail is a mailing list, other than in a case where a file acquired from the file server 105 is sent to a person without the access authority by file-attached mail, whether or not users included in the mailing list are within the range of the access authority can be judged, even when the file is sent to the addresses of the mailing list by file-attached mail, by the manager 121 inquiring of the mail server 104 of mail addresses included in the mailing list and then inquiring of the directory server 102 of those mail addresses.

Furthermore, regarding the output operation to upload a file into the web server 103, the manager 121 inquires of the directory server 102 about the access authority information of the web server 103 which is the output destination, in the same manner as the authority information of the acquisition source; and if the web server 103 which is the output destination has the access authority information, the manager 121 can check it against the access authority information of the acquisition source and judge whether or not the web server 103 which is the output destination is within the range of the access authority.

(First Variation)

If the file acquisition source type 302 is “Web Download” when identifying the file acquisition source in step S1104 of FIG. 11, the manager 121 judges, based on an acquisition source URL, whether it is a web server inside the company or not; and if the URL indicates that it is a web server outside the company, the manager 121 determines that the access authority over the file is not set; and terminates the processing without executing the processing in step S1106 and subsequent steps.

On the other hand, if the URL indicates in step S1104 of FIG. 11 that it is a web server inside the company, the manager 121 executes the processing in step S1105 and inquires of the directory server 102 about a disclosure range (access authority over the web server inside the company) of the web server which is the acquisition source; and if the access authority is set to the web server inside the company, the manager 121 registers information indicating the addition of the server access authority about the file, in a record of the acquired information management table 212.

(Second Variation)

If the file acquisition source type 302 is “Mail” when identifying the file acquisition source in step S1104 of FIG. 11, the manager 121 executes the specifying processing by tracking the acquisition source back to a mail sender. If the file is received by the user terminal 106 by mail under this circumstance, “Sender's Mail Address” is registered in the acquisition source information 303 of the acquisition source management table 224. In this case, the manager 121 inquires of the directory server 102 about the account name as the user information with respect to the registered sender's mail address.

Subsequently, the manager 121 searches the operation logs, which are collected from each user terminal 106, for the operation by the user who is the sender to sent the relevant file by mail, based on the account name of the received file and the identifier of the relevant file, specifies the user terminal 106 of the user who is the sender, based on the search result, and then searches for a record of the file identifier in the specified user terminal 106 based on information recorded in the acquired information management table 212. If the mail sender has acquired the file from the file server 105 or the web server 103 under this circumstance, the manager 121 executes the processing in step S1106 and subsequent steps. Also, if the mail sender has further received a file by mail, the manager 121 further similarly tracks back to its mail sender and repeats the processing for identifying the acquisition source.

(Third Variation)

If the file acquisition source type 302 is “Newly Created” when identifying the file acquisition source in step S1104 of FIG. 11, the manager 121 specifies the access authority based on other operations with respect to the newly created file.

Furthermore, if the “file-attached mail transmission operation” is extracted as the file output operation in step S1103 of FIG. 11 and this file acquisition source type 302 is “Newly Created,” the manager 121 searches for processing on the newly created file and extracts the operation to copy or move the file to the file server 105 or the operation to upload the file into the web server inside the company. If the manager 121 extracts the operation under this circumstance, the manager 121 executes the acquisition source access authority specifying processing as the processing in step S1203 and subsequent steps by using the file path of the file server 105 or the server name of the web server, which is registered in the acquisition source information in the acquired information management table 212, and registers the access authority information, which is acquired by this processing, in the acquired information management table 212.

Furthermore, if the processing for registering the newly created file in the file server 105 or updating it to the web server inside the company, the manager 121 determines that the access authority is not particularly designated.

Instead of specifying the user, who is the output destination, based on the mail address and judging whether or not the specified user is a user within the range of the access authority, it is possible to use a method of specifying the output destination of the file by using an IP address of the device. Under this circumstance, the directory server 102 adds the IP address of the device used by the user to the user information in FIG. 7 and manages it.

For example, if the user performs the file output operation by designating the user terminal 106 as a destination by means of peer-to-peer communication like a messenger, the agent 123 registers a destination IP address as the second supplementary information in an operation log. The manager 121 inquires of the directory server 102 about the user information with respect to the destination IP address during the output destination specifying processing in step S1106 of FIG. 11, reads the authority group information of a user corresponding to the destination IP address, and executes the processing in step S1107 and subsequent steps based on the read information in the same manner as in the case of mail output.

According to this embodiment, it is possible to specify the addressee user who can access the output destination of the output target file, which is the target of the user's output operation, and monitor whether or not the access authority over the acquisition source of the output target file exists as the access authority relating to the specified addressee user.

Furthermore, if each employee operates the user terminal 106 and the administrator operates the management server 101, the administrator can become aware of the status of operations by each employee to output information to persons outside the disclosure range (persons outside the range of the access authority), by viewing the screen in FIG. 14 according to this embodiment. Under this circumstance, the administrator can easily perceive the reality of bringing out intra-company information and implement appropriate measures such as a warning to an employee who performed the output operation.

### Second Embodiment

This embodiment is designed so that the agent 123, instead of the manager 121, executes the output destination specifying processing and the problem operation judgment processing and other structures are similar to those of the first embodiment. Under this circumstance, the agent 123 has functions of the respective parts included in the manager 121 (the PC information collection part, the output operation extraction part, the access authority information specification part, the user information specification part, the operation judgment part, and the risk information output part), manages information of the same tables as those managed by the manager 121, and records the user's input/output operation in the log management table 223 and the acquisition source management table 224; and when the agent 123 detects the user's operation to output a file and records that operation content in the operation log information management table 211, the agent 123 inquires of the directory server 102 about output destination information (a mail address under this circumstance) and specifies a user at the output destination, that is, an addressee user who can access the output destination of the output target file, based on information acquired from the directory server 102. Then, the agent 123 refers to the acquired information management table 212 and judges whether or not the user at the output destination is a user within the range of the access authority over the acquisition source.

If the agent 123 determines that the user at the output destination is a user outside the access authority over the acquisition source, it outputs a warning message as risk information about the user's output operation to a display screen on the user terminal 106. When this happens, the agent 123 sends the judgment result to the manager 121. The manager 121 displays the judgment result from the agent 123 on the screen and outputs the result of the entire system in the same manner as in the first embodiment.

Furthermore, when the output operation such as mail transmission is executed, the agent 123 secures a file in a buffer before the file is output to the network 107; and if it is determined that the user at the output destination is a user within the range of the access authority over the acquisition source, the agent 123 can stop outputting the file.

According to this embodiment, whether or not the user at the output destination is a user within the range of the access authority over the acquisition source can be managed at each user terminal 106; and if the user at the output destination is a user outside the range of the access authority over the acquisition source, output of the file can be stopped before the file is output to the network 107.

Incidentally, the present invention is not limited to the aforementioned embodiments, and includes various variations. For example, the aforementioned embodiments have been described in detail in order to explain the invention in an easily comprehensible manner and are not necessarily limited to those having all the configurations explained above. Furthermore, part of the configuration of a certain embodiment can be replaced with the configuration of another embodiment and the configuration of another embodiment can be added to the configuration of a certain embodiment. Also, part of the configuration of each embodiment can be added to, or deleted, or replaced with, the configuration of another configuration.

Furthermore, a part or whole of each of the aforementioned configurations, functions, processing units, processing means, and so on may be realized by hardware by, for example, designing them in integrated circuits. Also, each of the aforementioned configurations, functions, and so on may be realized by software by processors interpreting and executing programs for realizing each of the functions. Information such as programs, tables, and files for realizing each of the functions may be recorded and retained in memories, storage devices such as hard disks and SSDs (Solid State Drives), or storage media such as IC (Integrated Circuit) cards, SD (Secure Digital) memory cards, and DVDs (Digital Versatile Discs).

### REFERENCE SIGNS LIST

101 management server, 102 directory server, 103 web server, 104 mail server, 105 file server, 106 user terminal, 107 network, 111 CPU, 112 memory, 113 secondary storage device, 114 input/output interface, 115 network interface, 121 manager program, 123 agent program.

1. A computer system including a plurality of computer apparatuses connected to a network, the computer apparatuses for processing information by using computer resources,
wherein each computer apparatus comprises:
an operation recording part for recording, based on a user's input/output operation, operation log information including an operation type of the user's input/output operation and an output destination of a file selected by the user's input/output operation, and acquisition source information indicating an acquisition source of the file;
an information collection part for collecting the operation log information and the acquisition source information from the operation recording part, recording the collected operation log information by associating it with each information processing terminal, and recording the collected acquisition source information by relating it with an access authority over the acquisition source of the file;
a specification part used when the operation log information recorded for the user's output operation exists in the collected operation log information, for specifying a range of the access authority over the acquisition source of an output target file, which is a target of the user's output operation, based on the acquisition source information and specifying an addressee user who can access an output destination of the output target file based on user information;
a judgment part for judging whether or not the addressee user belongs to the range of the access authority over the acquisition source of the output target file, based on access control information and the user information; and
a risk information output part used if the judgment part obtains a negative judgment result, for outputting risk information indicating that the user's output operation is an output operation by the user outside the range of the access authority over the acquisition source of the output target file.

2. A computer system according to claim 1, wherein when the judgment part obtains a negative judgment result, the risk information output part outputs a warning to the user as the risk information about the user's output operation.

3. A computer system according to claim 2, wherein one computer apparatus among the plurality of computer apparatuses is constructed as a management server, whose management targets are other computer apparatuses, and the other computer apparatuses are constructed as user terminals operated by the user,
wherein the management server includes the information collection part, the specification part, the judgment part, and the risk information output part, and
wherein the user terminal includes the operation recording part.

4. A computer system according to claim 3, wherein if file-attached mail transmission exists as the operation type in the operation log information recorded by the information collection part, the specification part determines that the operation log information recorded for the user's output operation exists.

5. A computer system according to claim 4, wherein the information collection part is a server performing centralized management of resource information of the user terminals and user information about the user and obtains the access control information and the user information from a directory server connected to the network, and
wherein if the access authority over the acquisition source of the output target file which is the target of the user's output operation does not exist in the acquisition source information, the specification part specifies the range of the access authority over the acquisition source of the output target file based on the access control information acquired by the information collection part and specifies the addressee user based on the user information acquired by the information collection part.

6. A computer system according to claim 5, wherein the judgment part judges, based on the access control information and the user information which are acquired by the information collection part, whether or not a group to which the addressee user belongs exists in groups which has the access authority over the acquisition source of the output target file as the access authority relating to the addressee user.

7. A security management method for a computer system including a plurality of computer apparatuses connected to a network, the computer apparatuses for processing information by using computer resources,
wherein each computer apparatus executes:
an operation recording step of recording, based on a user's input/output operation, operation log information including an operation type of the user's input/output operation and an output destination of a file selected by the user's input/output operation, and acquisition source information indicating an acquisition source of the file;
an information collection step of collecting the operation log information and the acquisition source information which are recorded in the operation recording step, recording the collected operation log information by associating it with each information processing terminal, and recording the collected acquisition source information by relating it with an access authority over the acquisition source of the file;
a specification step executed when the operation log information recorded for the user's output operation exists in the operation log information collected in the information collection step, for specifying a range of the access authority over the acquisition source of an output target file, which is a target of the user's output operation, based on the acquisition source information and specifying an addressee user who can access an output destination of the output target file based on user information;
a judgment step of judging whether or not the addressee user belongs to the range of the access authority over the acquisition source of the output target file, based on access control information and the user information; and
a risk information output step executed if a negative judgment result is obtained in the judgment step, of outputting risk information indicating that the user's output operation is an output operation by the user outside the range of the access authority over the acquisition source of the output target file.

8. A security management method according to claim 7, wherein if a negative judgment result is obtained in the judgment step, each computer apparatus outputs a warning to the user as the risk information about the user's output operation in the risk information output step.

9. A security management method according to claim 8, wherein one computer apparatus among the plurality of computer apparatuses is constructed as a management server, whose management targets are other computer apparatuses, and the other computer apparatuses are constructed as user terminals operated by the user,
wherein the management server executes the information collection step, the specification step, the judgment step, and the risk information output step, and
wherein the user terminal executes the operation recording step.

10. A security management method according to claim 9, wherein if file-attached mail transmission exists as the operation type in the operation log information recorded in the information collection step, it is determines in the specification step that the operation log information recorded for the user's output operation exists.

11. A security management method according to claim 10, wherein in the information collection step, the management server is a server performing centralized management of resource information of the user terminals and user information about the user and obtains the access control information and the user information from a directory server connected to the network, and
wherein in the specification step, if the access authority over the acquisition source of the output target file which is the target of the user's output operation does not exist in the acquisition source information, the management server specifies the range of the access authority over the acquisition source of the output target file based on the access control information acquired in the information collection step and specifies the addressee user based on the user information acquired in the information collection step.

12. A security management method according to claim 11, wherein in the judgment step the management server judges, based on the access control information and the user information which are acquired in the information collection step, whether or not a group to which the addressee user belongs exists in groups which has the access authority over the acquisition source of the output target file as the access authority relating to the addressee user.
